(19) United States
(12) Patent Application Publication
(10) Pub. No.: US 2007/0005782 A1
(43) Pub. Date: Jan. 4, 2007

(54) Traffic messaging system

(75) Inventor: Hao Zheng, Cupertino, CA (US)

Correspondence Address: MORRISON & FOERSTER LLP, 755 PAGE MILL RD, PALO ALTO, CA, 94304-1018, US

(73) Assignee: Yahoo! Inc., Sunnyvale, CA (US)

(21) Appl. No.: 11/112,316

(22) Filed: Apr. 21, 2005

Related U.S. Application Data
(60) Provisional application No. 60/622,416, filed on Oct. 26, 2004.

(51) Int. Cl. G06F 15/16

(52) U.S. Cl. 709/230

(57) ABSTRACT

According to the invention, a digital message system for receiving a plurality of digital messages is disclosed. The digital message system includes a message receiving function, a message grouping function and a traffic shaping unit. The message receiving function interacts with the first and second digital messages. The message grouping function associates a first digital message and a second digital message to a group that are similar in at least one way. The traffic shaping unit does not delay delivery of the first digital message, but delays a second digital message. Messages are delayed when traffic for the group compares unfavorably with a traffic profile for the group.

This application claims the benefit of and is a non-provisional of U.S. application Ser. No. 60/622,416 filed on Oct. 26, 2004, which is incorporated by reference in its entirety for all purposes.

### BACKGROUND OF THE DISCLOSURE

This disclosure relates in general to messaging systems and, more specifically, but not by way of limitation, to systems that impede unsolicited messages.

The process of detecting and blocking unsolicited electronic mail is ever evolving. Unsolicited mailers are always modifying their techniques to overcome any type of filtering. One current threat is unsolicited mailers that use armies of hacked host computers to send electronic mail messages. These mail messages are difficult to block with blacklisting filters that block Internet protocol (IP) addresses known to be used by unsolicited mailers since the army of hacked host computers can be large.

Unsolicited mailers are also using many different domain names in their messages such that URL filters cannot easily determine an electronic mail message is unsolicited. These domain names can change often enough to not trigger URL filters. Before URL filters have time to update, the unsolicited mailer can move to using another domain.

Various unsolicited mail filtering techniques take time to update their algorithms to detect new attacks. User reports and filter engine technicians can be involved in updating the algorithms such that human delay is unavoidable. Some unsolicited mailers take advantage of this by sending millions of messages before the unsolicited mail filtering technique can adapt to the new technique.

Some unsolicited mail filtering techniques use the DNS information. An unsolicited mailer might delay setting up their DNS records or take their websites offline until the unsolicited messages are sent. These techniques used by unsolicited mailers make it difficult to quickly detect the domains from the DNS record.

### BRIEF DESCRIPTION OF THE DRAWINGS

The present disclosure is described in conjunction with the appended figures:

FIG. 1 is a block diagram of one embodiment of an e-mail distribution system;

FIGS. 2A and 2B are block diagrams of embodiments of the messaging system;

FIGS. 3A-3E are charts that characterize embodiments of the messaging system;

FIG. 4 is an embodiment of an unsolicited e-mail message exhibiting conventional techniques used by unsolicited mailers;

FIGS. 5A-5E are flow diagrams of embodiments of a process for message handling; and

FIGS. 6A and 6B are flow diagrams of embodiments of a process for updating a block buffer used in the message handling process.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE PREFERRED EMBODIMENT

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures,. and techniques may be shown without unnecessary detail in order to avoid obscuring the embodiments.

Also, it is noted that the embodiments maybe described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

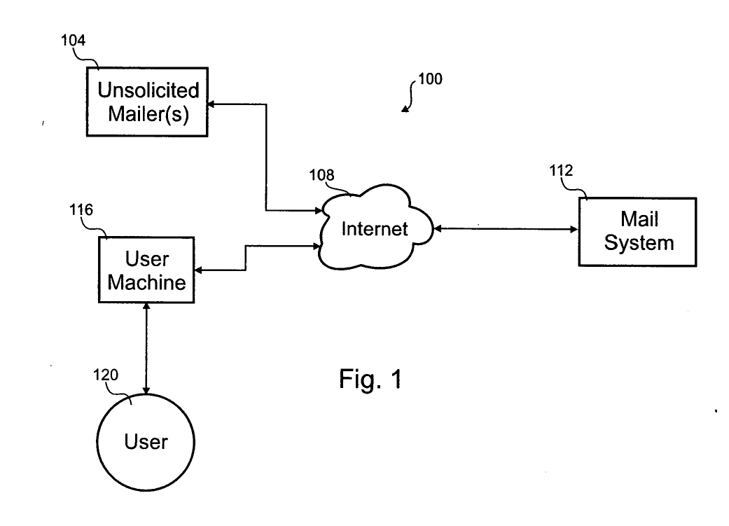

Referring first to FIG. 1, a block diagram of one embodiment of an e-mail distribution system 100 is shown. Included in the distribution system 100 are an unsolicited mailer 104, the Internet 108, a mail system 112, and a user machine 116. The Internet 108 is used to connect the unsolicited mailer 104, the mail system 112 and the user, although, direct connections or other wired or wireless networks could be used in other embodiments.

The unsolicited mailer 104 is a party that sends e-mail indiscriminately to thousands and possibly millions of unsuspecting users 120 in a short period time. Usually, there is no preexisting relationship between the user 120 and the unsolicited mailer 104. Often, an unsolicited mailer 104 sends unsolicited messages that violate one or more laws governing the bulk distribution of electronic messaging. The unsolicited mailer 104 often sends an e-mail message with the help of a list broker. The list broker provides the e-mail addresses of the users 120, grooms the list to keep e-mail addresses current by monitoring which addresses bounce and adds new addresses through various harvesting techniques.

The unsolicited mailer provides the e-mail message to the list broker for processing and distribution. Software tools of the list broker insert random strings in the subject, forge e-mail addresses of the sender, forge routing information, select open relays to send the e-mail message through, use of armies of zombie computers that are hacked to act as mail relays, and use other techniques to avoid detection by conventional detection algorithms. The body of the unsolicited e-mail often contains patterns similar to all e-mail messages broadcast for the unsolicited mailer 104. For example, there is contact information such as a phone number, an e-mail address, a web address, or postal address in the message so the user 120 can contact the unsolicited mailer 104 in case the solicitation triggers interest from the user 120. This contact information and other common keywords can serve as a characteristic to group similar messages.

The mail system 112 receives, filters and sorts e-mail from legitimate and illegitimate sources. Separate folders within the mail system 112 store incoming e-mail messages for the user 120. The messages that the mail system 112 suspects are unsolicited mail are stored in a folder called “Bulk Mail” and all other messages are stored in a folder called “Inbox.” When mail is sent to the Inbox, it may be further sorted into other folders.

In this embodiment, the mail system 112 is operated by an e-mail application service provider (ASP). The e-mail application along with the e-mail messages are stored in the mail system 112. The user 120 accesses the application remotely via a web browser without installing any e-mail software on the computer 116 of the user 120. In alternative embodiments, the e-mail application could reside on the computer of the user and only the e-mail messages would be stored on the mail system 112.

The user machine 120 is a subscriber to an e-mail service provided by the mail system 112. An Internet service provider (ISP) connects the user machine 116 to the Internet 108. The user 120 activates a web browser application on the user machine 116 and enters a universal resource locator (URL) which corresponds to an internet protocol (IP) address of the mail system 112. A domain name server (DNS) translates the URL to the IP address, as is well known to those of ordinary skill in the art.

Although this embodiment is explained in the context of an electronic mail distribution system, the invention should not be so limited. The invention could be applied to any messaging system that receives electronic messages that might include unsolicited messages. The digital message could be an electronic mail message, a chat room comment, an instant message, a pager message, a text message, a mobile phone message, an automatically sent voice mail message, an automatically sent fax message, a newsgroup posting, an electronic forum posting, a message board posting, and/or a classified advertisement.

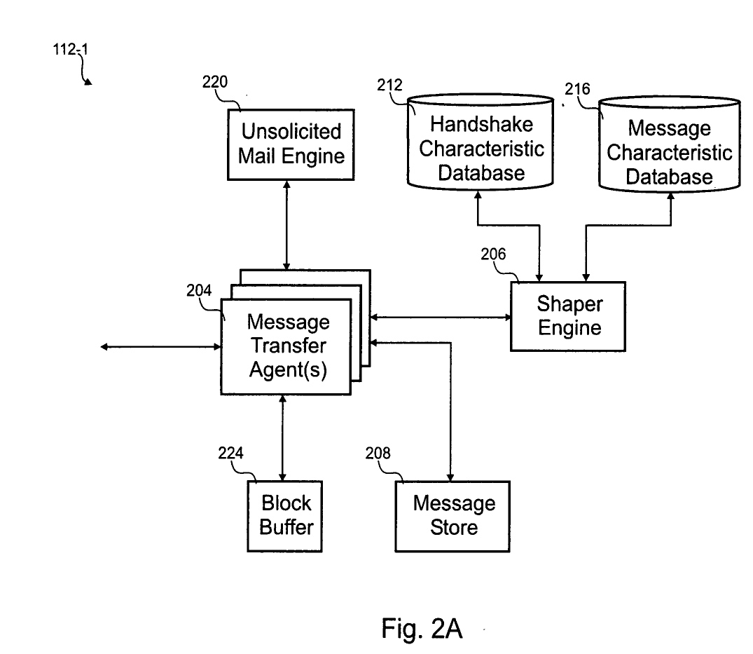

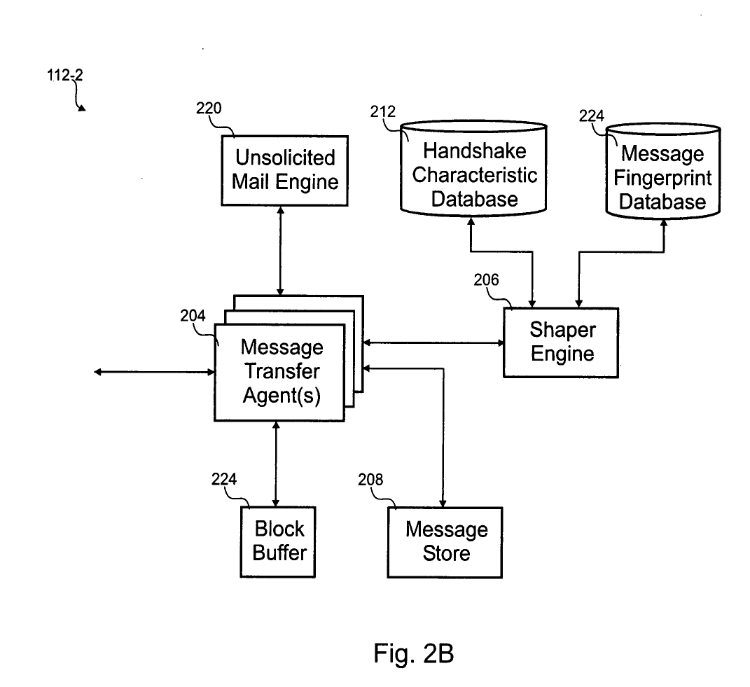

With reference to FIG. 2A, a block diagram of an embodiment of the messaging system 112-1 is shown. This embodiment throttles back acceptance of messages where unusual traffic patterns are recognized. Messages are grouped together using sending IP address, a range of sending IP addresses, a characteristic that identifies messages are associated in some way, fingerprint matching of messages, and/or other methods of grouping messages together. Receipt of groups that are larger than expected over a time period can have their messages delayed to allow time for the unsolicited message algorithm to filter messages in that group if they are likely to be unsolicited. The messaging system 112-1 includes one or more message transfer agents 204, a block buffer 224, a message store 208, a shaper engine 206, an unsolicited mail engine 220, a handshake characteristic database 212, and a message characteristic database 216.

The message transfer agent 204 receives messages and stores them in the message store 208, but may sort them as unsolicited with the help of the unsolicited mail engine 220. Various techniques can be used to match messages to determine if they are likely unsolicited. These techniques include pattern matching, keyword detection and velocity checks. Generally, a new type attack causes the unsolicited mail engine 220 to adapt to that new attack and start filtering messages properly into the message store in a way that flags them as likely to be unsolicited.

The shaper engine 206 works to update a block buffer 224 that stores information used to delay messages that vary from a volume or increase in volume profile. The block buffer 224 includes identifiers for groups of messages that the shaper engine determines should be slowed down. Identifiers added to the block buffer 224 expire after a period of time and are removed. The period generally correlates to a latency of the unsolicited mail engine 220 in adapting to filter new unsolicited message threats. That latency may vary based upon volume, time of day, processor loading, size of group, and/or type of identifier. Some embodiments could have a global expiration period for all identifiers for all time, a global expiration period that changes as the predicted latency changes and/or a latency customized for one or more identifiers.

The shaper engine 206 is coupled to a message characteristic database 216 and a handshake characteristic database 212. As messages that are not yet identified as unsolicited, corresponding characteristics are added to the databases 212, 216 as well as updating the traffic measurements for each of these characteristics. These databases track characteristics that would identify a group of messages. A given message may correspond to more than one characteristic. As the unsolicited mail engine identifies a characteristic identifies messages that are likely to be unsolicited, that characteristic can be moved to another database used for unsolicited mail detection.

The message characteristic database 216 stores various characteristics that are common to a group of messages, for example, a URL, a phone number, an address, a file name, a keyword, a size of an embedded file, a size of the message, a word count, use of an open relay, addressee or sender address, or any other way of categorizing a message into a group. For each characteristic that identifies a group, a traffic limit is specified before a characteristic would be added to the block buffer. These traffic limits include a traffic versus time profile, a maximum running average, a traffic threshold for a period of time, a maximum acceleration in traffic, or other limit to traffic is specified in the message characteristic database 216.

The handshake characteristic database 212 stores characteristics that can be gathered in the protocol-level handshake when a message is received. For example, the SMTP protocol for electronic mail messages specifies handshaking to determine if a message should be received. The handshake characteristic database 212 includes traffic limits for each characteristic. The characteristics include source IP address, a range of source IP addresses, a domain corresponding to a source IP address, and/or other information that is gathered in the message handshake.

Referring next to FIG. 2B, a block diagram of another embodiment of the messaging system 112-2 is shown. In this embodiment, a message fingerprint database 224 replaces the message characteristic database 216 for FIG. 2A. Each message is given one or more codes that identify the message that are stored in the message fingerprint database 224. Subsequent messages that match some or all of the codes in the message fingerprint are grouped together. Traffic measurements are compared against a traffic limit for each group associated with a particular fingerprint to possibly add a given fingerprint to the block buffer 224. The grouping by fingerprint allows pattern matching between messages. If a given fingerprint is ultimately noted as corresponding to a likely unsolicited message, the fingerprint can be removed from the message fingerprint database 224 and added to a database of fingerprints for unsolicited messages.

There are many different ways to manage the delay of messages with various algorithms. One goal in one embodiment is to determine traffic rate and the change in traffic rate information. However, calculating the first and second derivatives for millions of unique characteristics or fingerprints can be both CPU and memory intensive, although this could be done in some embodiments. To improve scalability, one embodiment uses a modified leaky bucket algorithm approximation. We compare short-term behavior with the normal behavior to analyze traffic patterns and to automatically adapt to any prolonged changes in behavior. This embodiment is also capable of filtering out transient anomalies.

Each characteristic or fingerprint of the incoming messages triggers an event for the shaper engine 206. The shaper engine 206 flags characteristics or fingerprints that come in at a rate significantly higher than their normal rate. Flagged characteristics or fingerprints are added to the block buffer 224.

The shaper engine 206 keeps track of the following states, where an event is a matched characteristic or fingerprint in our example:
Rate(event, transient): transient event rate
Rate(event, stable): long-term event rate
Rate(event, allowed): current allowed event rate
Reserve(event): bucket size or accumulated reserve

The shaper engine 206 tracks the transient rate of an event, Rate(event, transient), to the allowed rate, Rate(event, allowed). If the current rate is less than the allowed rate, the difference is added to the “bucket reserve,” Reserve(event). Otherwise, the rate of reduction of the reserve (i.e., leakage of the bucket) is generally proportional to the difference between the transient rate and the allowed rate. When the Reserve of a particular characteristic or fingerprint is completed drained, the event is flagged as abnormal and the block buffer 224 is updated accordingly. Below is an example of pseudo-code for this.

```
overlimit = 0
Reserve(event) = Reserve(event) + (Rate(event, allowed) − Rate(event,
transient
if [ Reserve(event) < 0 ]
then
    overlimit = −Reserve(event)
    Reserve(event) = 0
endif
```

Each characteristic or fingerprint of the incoming messages triggers an event for the shaper engine 206. The shaper engine 206 flags characteristics or fingerprints that come in at a rate significantly higher than their normal rate. Flagged characteristics or fingerprints are added to the block buffer 224.

In one embodiment, the allowed rate is linearly adjusted to track the transient rate so that the system is adaptive, based on the following formula, where K denotes how quickly the behavior change can be accepted as normal:

```
if [ Rate(event, allowed) < Rate(event, transient) ]
then
    Rate(event, allowed) = Rate(event, allowed) + K * interval
else
    Rate(event, allowed) = Rate(event, allowed) − K * interval
    if [ Rate(event, allowed) < Rate(event, stable) ]
    then
    Rate(event, allowed) = Rate(event, stable);
    endif
endif
```

Other embodiments could use other algorithms to detect abnormal increases in a characteristic or fingerprint to cause delay.

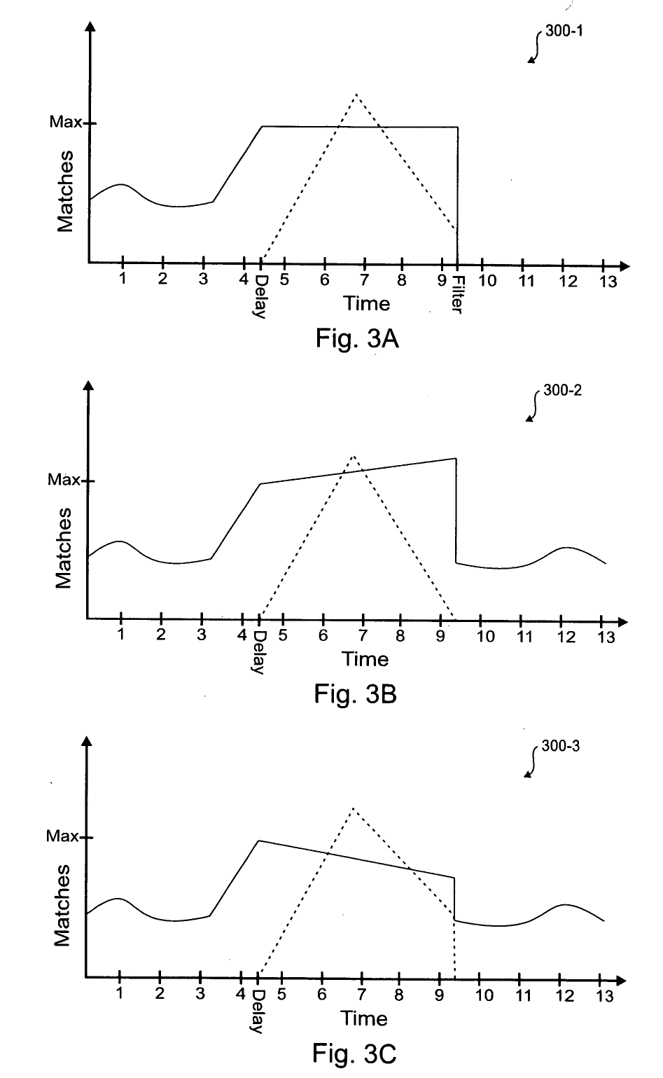

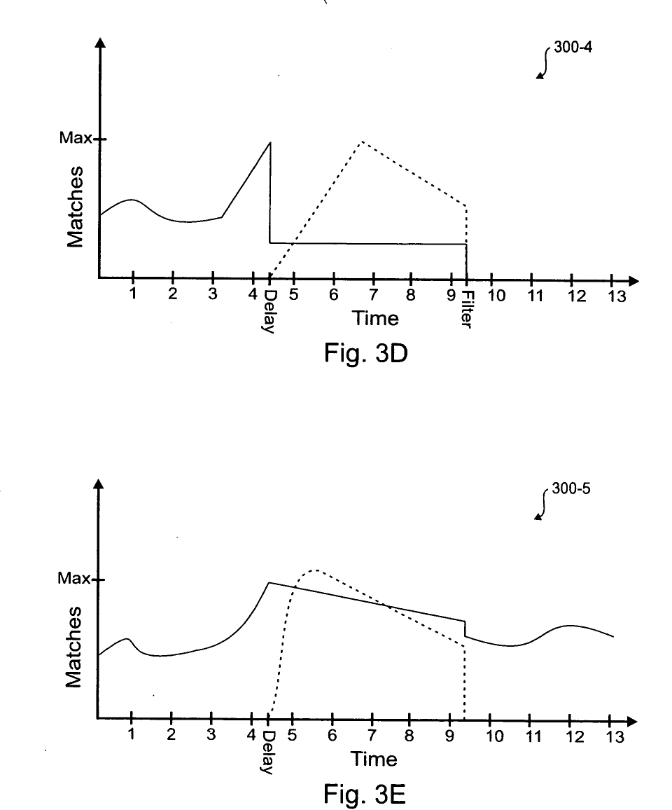

With reference to FIG. 3A, a chart is shown 300-1 that characterizes an embodiment of the messaging system 112. This embodiment has a maximum traffic threshold for a traffic limit after which messages are delayed to maintain traffic below the maximum traffic threshold. The solid line in the chart 300-1 corresponds to received messages, while the dotted line corresponds to delayed messages. In this embodiment, delay begins a 4.4 seconds where the shaper engine adds the characteristic or fingerprint to the block buffer 224 and clamps traffic to the maximum traffic threshold. At 9.3 seconds, the unsolicited message filter adapts to recognize that the characteristic or fingerprint corresponds to messages that are likely to be unsolicited. Further traffic associated with the characteristic is blocked after the filter point.

Referring next to FIG. 3B, a chart is shown 300-2 that characterizes an embodiment of the messaging system 112. The solid line in the chart 300-2 corresponds to received messages, while the dotted line corresponds to delayed messages. This embodiment allows the amount of traffic to slowly increase after the traffic limit. The traffic increase in this embodiment is not associated with messages that are likely to be unsolicited and just a normal increase in traffic for a solicited mailer. The traffic limit increase makes a subsequent increase in traffic less likely to trigger delays. In this way, periodic mailers are less likely to see their messages delayed. If the traffic limit is not reached in a period of time, the traffic limit can be slowly decreased. The temporary increase in traffic ends at 9.3 seconds without any filtering in this embodiment.

The amount of time a message is delayed may be adjusted according to any number of factors, for example, the magnitude of the traffic, the loading on the message system 100, the likelihood the group of messages are unsolicited, etc. Delay of messages can take several forms. Some embodiments slow the SMTP handshake process to impose the delay. Other embodiments send an error message to the sending server asking it to try back later. One embodiment sends a mail message to the sender asking it to try again later. Where the mail message bounces, the characteristic or fingerprint may be moved to the unsolicited mail engine as a bounced mail address may indicate the sender e-mail address is forged.

With reference to FIG. 3C, a chart 300-3 is shown that characterizes an embodiment of the messaging system 112. The solid line in the chart 300-3 corresponds to received messages, while the dotted line corresponds to delayed messages. This embodiment reduces the allowed traffic after a traffic limit is reached. A running average of traffic is monitored and once the running average reaches the traffic limit, the traffic limit is reduced over time. The traffic limit may be increased if the characteristic or fingerprint is not associated with an unsolicited mailer after a time period which would normally allow making that determination.

Other embodiments may set the traffic limit as a multiplier of the average traffic. For example, increases of four fold over the average in the last week will not trigger the delay algorithm, but greater increases would. One embodiment appreciates the periodicity of a traffic pattern allowing one day a month to have increased traffic, but not allowing as much traffic on other days for a message characteristic or fingerprint associated with monthly mailings.

Referring next to FIG. 3D, a chart 300-4 is shown that characterizes an embodiment of the messaging system 112. The solid line in the chart 300-4 corresponds to received messages, while the dotted line corresponds to delayed messages. This embodiment constricts traffic to a predetermined lower limit after a traffic limit is reached. Traffic is largely eliminated once the filter triggers.

With reference to FIG. 3E, a chart 300-5 is shown that characterizes an embodiment of the messaging system 112. The solid line in the chart 300-5 corresponds to received messages, while the dotted line corresponds to delayed messages. This embodiment measures a rising slope of the traffic and throttles back traffic by using delay when the rising slope or acceleration in traffic reaches the traffic limit. The traffic measurement may be smoothed to prevent spurious triggering of the algorithm. After a triggering event, the volume of traffic is reduced over time. Other embodiments could allow the volume to rise or hold it steady until the volume drops at some future time.

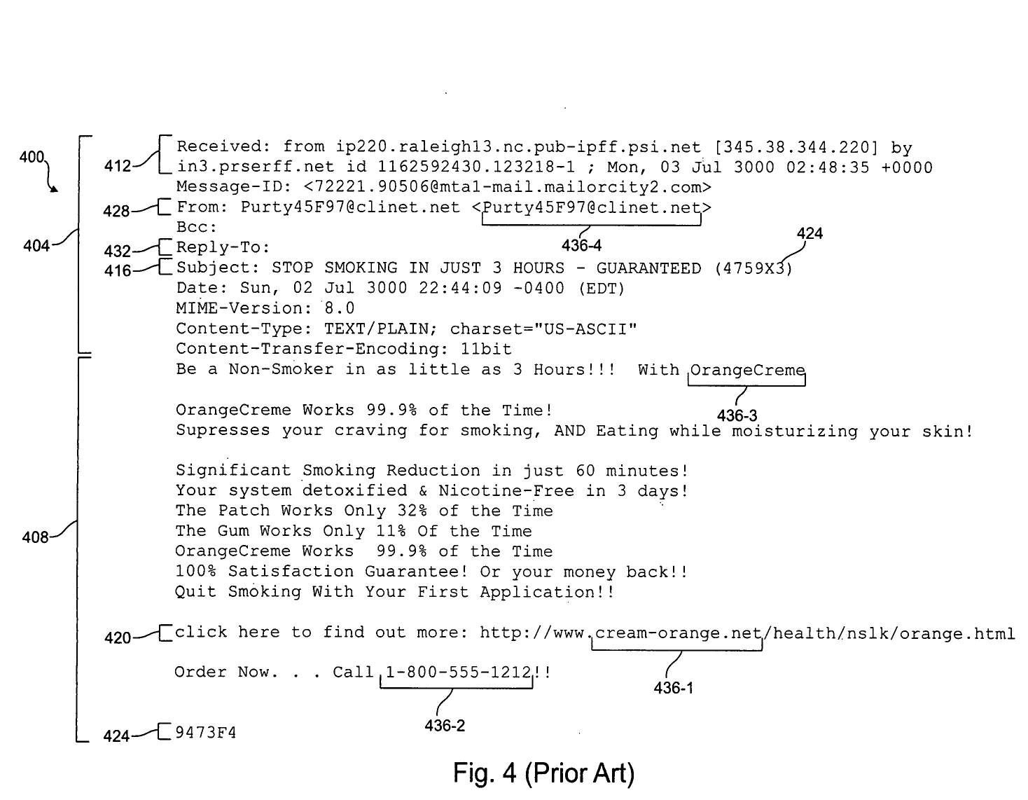

Referring next to FIG. 4, an embodiment of an unsolicited e-mail message 400 is shown that exhibits some conventional techniques used by unsolicited mailers 104. The message 400 is subdivided into a header 404 and a body 408. The message header 404 includes routing information 412, a subject 416, a sending party 428, a “reply-to” field 432 and other information. The routing information 412 along with the referenced sending party are often inaccurate in an attempt by the unsolicited mailer 104 to thwart attempts of a mail system 112 to block unsolicited messages from that source. Included in the body 408 of the message is the information the unsolicited mailer 104 wishes the user 120 to read. Typically, there is a URL 420 or other mechanism for contacting the unsolicited mailer 104 in the body of the message in case the message presents something the user 120 might be interested in.

To thwart an exact comparison of message bodies 408 or subject lines 416 when unsolicited e-mail is detected, an evolving code 424 is often included in the body 408 or subject line 416. In some cases, the body may also include evolving codes 424 and text that change to avoid pattern recognition. Most messages have certain characteristics 436 that are common to a group of messages. For example, a domain name characteristic 436-1, a telephone number characteristic 436-2, a keyword 436-3, a forged sender address 436-4, and/or other characteristics can be used to group messages. These are just some characteristics, but anything that can somewhat uniquely identify a message can be used as a characteristic in other embodiments. Where more than one characteristic 436 is gathered from a message 400 algorithms can be used to determine if the messages are similar enough to be included in a particular group or not.

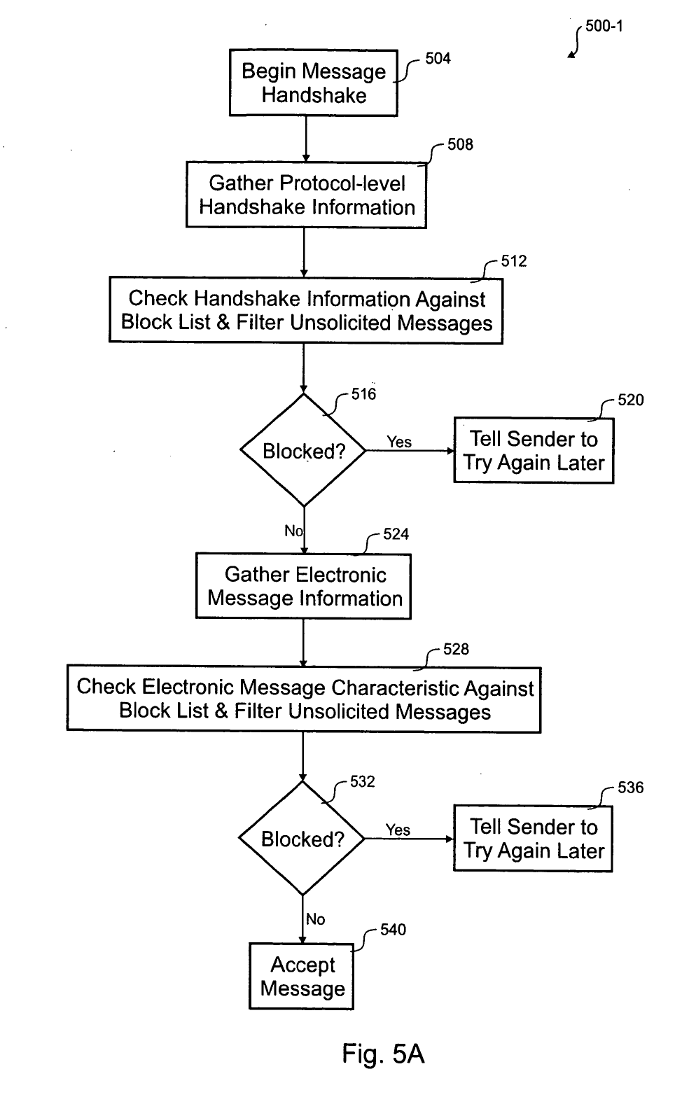

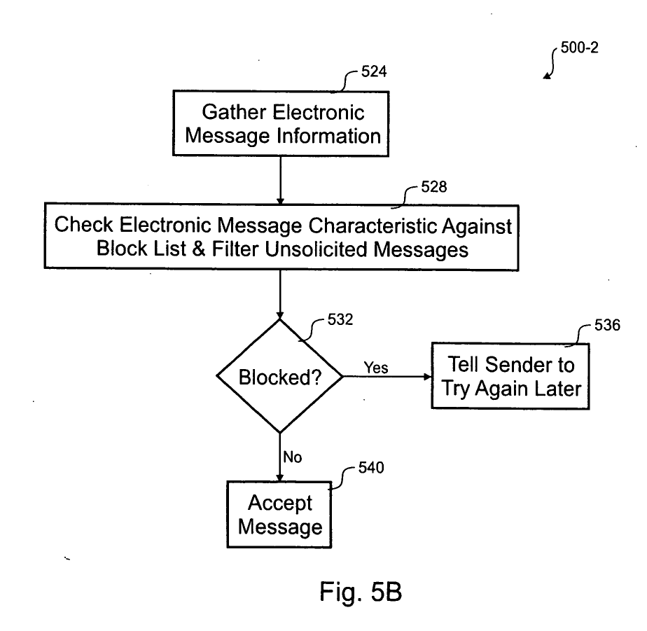

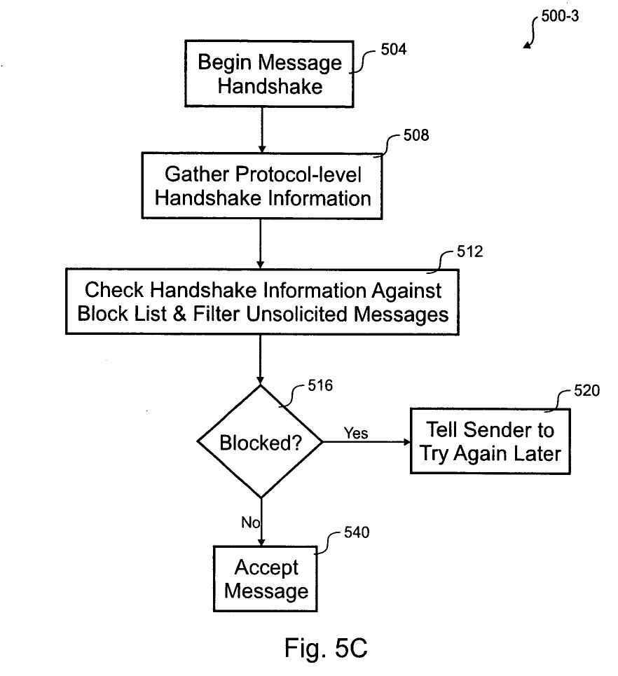

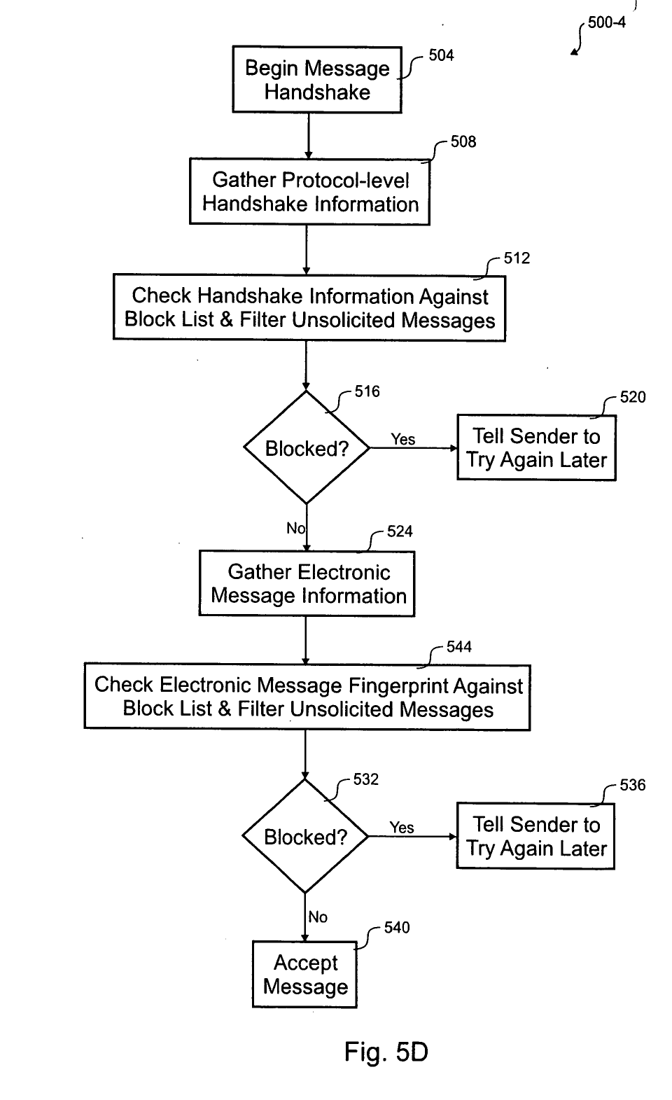

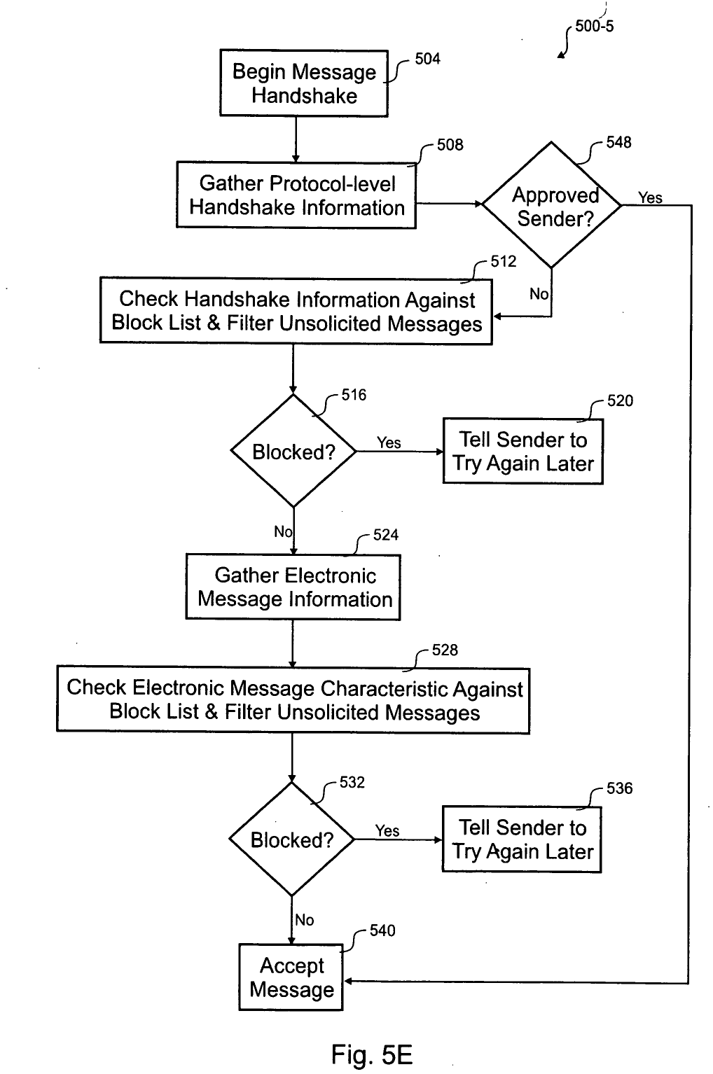

With reference to FIG. 5A, a flow diagram of an embodiment of a process 500-1 for message handling is shown. The depicted portion of the process begins in step 504 where a protocol-level handshake occurs to receive a message. The source IP address and other information is gathered in step 508 through this handshake. As the information is gathered, it is checked against the block buffer 224 in step 512. Step 512 can also detect unsolicited messages and filter them into a bulk mail folder, for example. A background process in this embodiment updates the block buffer 224 to indicate handshake information that corresponds to messages that should be delayed. In a parallel process or intertwined process, unsolicited messages can also be filtered as those skilled in the art appreciate.

For messages associated with handshake information indicated on the block buffer 224 as determined in step 516, the mail transfer agent 204 automatically tells the sender to try to send the message later in step 520. Where the message is not indicated on the block buffer 224 in step 516, information is gathered from the electronic message itself in step 524. This information can include both header 404 and body 408 for various types of electronic messages. In step 528, one or more characteristics 436 gathered from the message 400. Further filtering of unsolicited messages (i.e., filtering beyond step 512) may also occur in step 528 using information within the message 400. Other filtering of unsolicited messages may occur throughout the process 500-1 in various embodiments. Whenever a message is found to be unsolicited, the process 500-1 is stopped in this embodiment as the message will be sorted appropriately by the unsolicited message algorithms.

Comparing the characteristic(s) from the message 400 against the block buffer 224 occurs in step 532. Messages indicated by the block buffer 224 are sent to step 536 where the sender is automatically told to try sending the message 400 later. If the characteristic is not in the block buffer 224, step 540 will accept the message and process it normally. The block buffer information, may only affect some, but not all messages that have the indicated handshake or message characteristic. A limit could be put in block buffer 224 for each characteristic where only messages beyond the limit would be delayed. Other embodiments could add and remove the characteristic from the block buffer 224 to throttle acceptance of groups of messages to only allow some through during a time period.

Referring next to FIG. 5B, a flow diagram of another embodiment of a process 500-2 for message handling is shown. This embodiment includes steps 524-540 of FIG. 5A and does not perform delays based upon the protocol-level handshake information. Characteristics from the message 400 are analyzed to determine characteristics that can be checked against the block buffer 224 to possibly delay receipt of those messages.

With reference to FIG. 5C, a flow diagram of yet another embodiment of a process 500-3 for message handling is shown. This embodiment includes steps 504-520 and 540 of FIG. 5A to perform block buffer 224 checks for information gathered during the handshake. Subsequent checks of the received message are not performed in this embodiment.

Referring next to FIG. 5D, a flow diagram of still another embodiment of a process 500-4 for message handling is shown. This embodiment can perform handshake stage delay as in steps 504-520 of FIG. 5A. For the message itself, the message information is gathered in step 524. A fingerprint for the message is compared against fingerprints in the block buffer 224 in step 544 and checked to determine if the message is unsolicited. Fingerprints are a code or codes used to indicate a pattern match between the contents of two messages. The codes can have some that don't match between two messages with the messages still being grouped together to avoid small variances between messages. A fingerprint match to the delay buffer 224 will cause a message delay in step 536. Where a characteristic and/or fingerprint is used to conclude the message is likely unsolicited, the message is filtered accordingly without the need to continue the steps in this process 500-4.

Referring next to FIG. 5E, a flow diagram of still another embodiment of a process 500-5 for message handling is shown. In this embodiment, approved sender IP addresses or authenticated sources cause a message to be accepted in step 548 without checking the block buffer 224. This embodiment differs from that of FIG. 5A in that a new step 548 is performed between steps 508 and 512. Where the sender is approved processing goes from step 548 to step 540. For non-cleared sources, processing goes from step 548 to step 512.

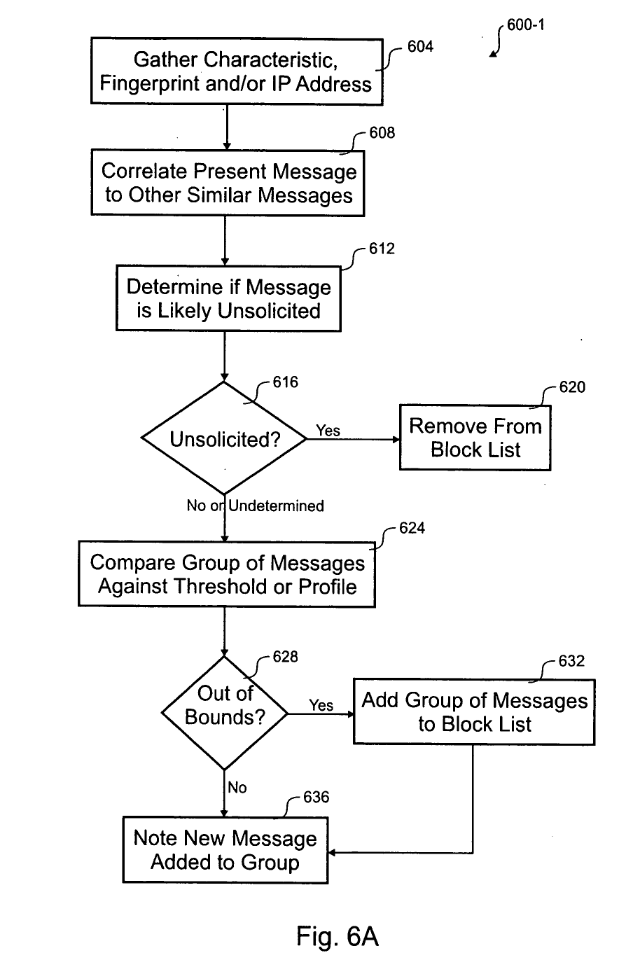

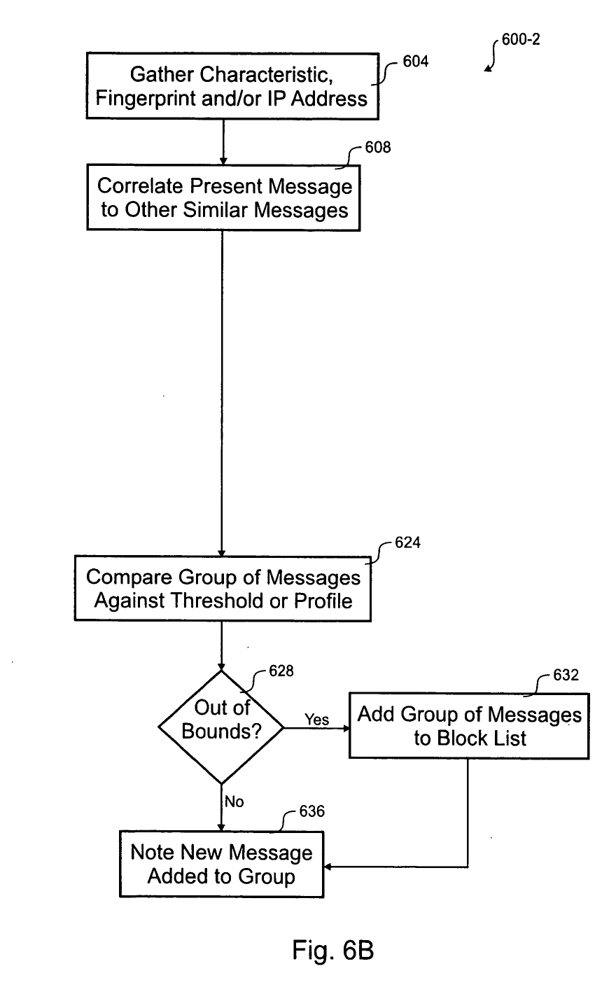

With reference to FIG. 6A, a flow diagram of an embodiment of a process 600-1 for updating the block buffer 224 used in the message handling process 500. This process 600-1 monitors groups of messages to update the block list in the block buffer 224 when a traffic limit is exceeded. The depicted portion of the process begins in step 604 where the identifier used to group a message is gathered. As discussed above, these identifiers include anything that can uniquely categorize messages, for example, message characteristics 436, handshake characteristics or fingerprints. In step 608, the message is correlated into a group of similar messages.

A determination in step 612 finds messages likely to be unsolicited. Unsolicited messages found in step 616 have their identifiers or characteristics removed from the block list of the block buffer 224. Unsolicited messages are filtered for the user such that delaying these messages is not performed. Although this embodiment does not delay messages found to be unsolicited, other embodiments may continue to delay receipt of unsolicited messages to tie-up the servers of unsolicited mailers to slow their ability to send unsolicited messages. The handshake process could include retries and errors given to the server of the unsolicited mailer to impede that servers ability to send large amounts of unsolicited mail.

Where a message cannot be identified as unsolicited in step 616, processing continues to step 624 where the group is compared against a traffic limit. If the traffic is out of the bounds defined by the traffic limit in step 628, processing continues to step 632 where the message identifier or characteristic is added to the block buffer 224. Messages identified in the block buffer 224 are delayed by the message transfer agent 204. Whether the message is added to the block buffer 224 or not, processing continues from steps 632 or 628 to step 636 where the message count is noted as traffic for the group.

Referring next to FIG. 6B, a flow diagram of an embodiment of a process 600-2 for updating the block buffer 224 used in the message handling process 500. This embodiment differs from that of FIG. 6A in that processing skips from step 608 to step 624 without removing unsolicited message identifiers from the block buffer 224. Delays occur for message groups even if they are likely unsolicited.

A number of variations and modifications of the disclosed embodiments can also be used. For example, embodiments could be used to delay any type of electronic messages sent in bulk and not just electronic mail messages. Some embodiments expire characteristics or identifiers used to group messages together. Expiration occurs at a time in which most groups of unsolicited messages would be caught by adaptations in the algorithms to find unsolicited messages. Delaying a certain group of messages would stop when detection is likely to have happened under the presumption that the group is probably solicited.

An exception mechanism is used in one embodiment to allow certain periodic burst of traffic events to go through without triggering the delay process. This is designed to avoid catching weekly newsletter type of bursty traffic as false-positives that would trigger dealy. The amount of traffic of any group of similar messages over a fixed amount of time (e.g., the last 2, 7, 30, or 90 days) is compared with the rate limit. If it exceeds the limit, the particular group is exempted from traffic shaping.

Another exception from triggering the delay process is done via an IP database of known good IP addresses or corresponding domains. This IP database is reversed for known good sites and internal sites that are unlikely to be associated with unsolicited messages. At the protocol-level handshake the sending IP address is checked against the IP database. Those IP addresses in the IP database are accepted without unsolicited message detection or triggering the delay process.

While the principles of the disclosure have been described above in connection with specific apparatuses and methods, it is to be clearly understood that this description is made only by way of example and not as limitation on the scope of the invention.

What is claimed is:

1. A digital message system for receiving a plurality of digital messages, the digital message system comprising:
a message receiving function that interacts the first and second digital messages;
a message grouping function that associates a first digital message and a second digital message with a group for being similar in at least one way; and
a traffic shaping unit that does not delay delivery of the first digital message, but delays a second digital message, wherein messages are delayed when traffic for the group compares unfavorably with a traffic profile for the group.

2. The digital message system for receiving the plurality of digital messages as recited in claim 1, further comprising a list that identifies the group for delay when the message receiving function interacts with the second digital message.

3. The digital message system for receiving the plurality of digital messages as recited in claim 1, wherein the message receiving function sorts messages into a message store.

4. The digital message system for receiving the plurality of digital messages as recited in claim 1, wherein the traffic shaping unit uses a leaky bucket algorithm when comparing the traffic for the group against the traffic profile for the group.

5. The digital message system for receiving the plurality of digital messages as recited in claim 1, wherein a delay of the second message is programmable.

6. The digital message system for receiving the plurality of digital messages as recited in claim 1, wherein first and second digital messages are chosen from the group consisting of an electronic mail message, a chat room comment, an instant message, a pager message, a mobile phone message, a newsgroup posting, an electronic forum posting, a message board posting, and a classified advertisement.

7. A method for enhancing filtration of electronic messages correlated to a group of similar electronic messages, the method comprising steps of:
receiving a first electronic message;
discovering the first electronic message is a member of the group;
analyzing the group a first time;
processing the first message without delaying receipt based, at least in part, upon the analyzing the group a first time;
discovering a second message is a member of the group;
analyzing the group a second time; and
delaying receipt of the second message for a period of time based, at least in part, upon the analyzing the group a second time.

8. The method for enhancing filtration of electronic messages correlated to the group of similar electronic messages as recited in claim 7, further comprising a step of determining that the group is likely unsolicited messages.

9. The method for enhancing filtration of electronic messages correlated to the group of similar electronic messages as recited in claim 7, wherein the analyzing steps comprise a step of detecting an increase in a size of the group over a time period.

10. The method for enhancing filtration of electronic messages correlated to the group of similar electronic messages as recited in claim 7, wherein the analyzing steps comprise a step of detecting a rate that a size of the group is increasing.

11. The method for enhancing filtration of electronic messages correlated to the group of similar electronic messages as recited in claim 7, wherein the analyzing steps comprise a step of comparing a size of the group to a historical profile for the group.

12. The method for enhancing filtration of electronic messages correlated to the group of similar electronic messages as recited in claim 7, wherein the discovering steps comprise a step of matching at least one of:
a source IP address of a message,
a keyword within the message, or
a message fingerprint that characterizes the message.

13. The method for enhancing filtration of electronic messages correlated to the group of similar electronic messages as recited in claim 7, wherein a delay imposed in the delaying step is affected by the second-listed analyzing step.

14. The method for enhancing filtration of electronic messages correlated to the group of similar electronic messages as recited in claim 7, further comprising steps of:
determining a time related to a latency for detecting the group is likely unsolicited, and
adjusting a delay imposed in the delaying step based, at least in part, on the immediately-preceding determining step.

15. A computer-readable medium having computer-executable instructions for performing the computer-implementable method for enhancing filtration of electronic messages correlated to the group of similar electronic messages of claim 7.

16. A computer system adapted to perform the computer-implementable method for enhancing filtration of electronic messages correlated to the group of similar electronic messages of claim 7.

17. A method for enhancing filtration of electronic messages correlated to a group of similar electronic messages, the method comprising steps of:
receiving a plurality of electronic messages;
grouping the plurality of electronic messages in the group based upon at least one similarity;
associating an electronic message with the group;
analyzing traffic for the group; and
delaying receipt of the electronic message for a period of time based, at least in part, upon the analyzing step.

18. The method for enhancing filtration of electronic messages correlated to the group of similar electronic messages as recited in claim 17, wherein the discovering steps comprise a step of matching at least one of:
a source IP address of a message,
a keyword within the message, or
a message fingerprint that characterizes the message.

19. The method for enhancing filtration of electronic messages correlated to the group of similar electronic messages as recited in claim 17, wherein the analyzing steps comprise a step of detecting an increase in a size of the group over a time period.

20. A computer-readable medium having computer-executable instructions for performing the computer-implementable method for enhancing filtration of electronic messages correlated to the group of similar electronic messages of claim 17.
